(19) United States
(12) Patent Application Publication
(10) Pub. No.: US 2022/0344736 A1
(43) Pub. Date: Oct. 27, 2022

(54) Heat treating apparatus for recovering lithume carbonate and an apparatus for recovering lithume carbonate using the same

(71) Applicant: DOOSAN ENERBILITY CO., LTD., Changwon (KR)

(72) Inventors: Jang Yong You, Suwon (KR); Wee Kwan Kang, Yongin (KR); Ho Yong Jo, Yongin (KR); Chae Soo Lee, Yongin (KR)

(21) Appl. No.: 17/524,760

(22) Filed: Nov. 12, 2021

(30) Foreign Application Priority Data
Apr. 23, 2021 (KR) 10-2021-0053109
Jun. 23, 2021 (KR) 10-2021-0081739

(51) Int. Cl. H01M 10/54; C01D 15/08; F27B 9/06; F27D 99/00; F27D 15/00

(52) U.S. Cl. CPC H01M 10/54; C01D 15/08; F27B 9/062; F27D 99/0033; F27D 15/00; F27D 2099/0053; F27D 99/0006

(57) ABSTRACT

A heat treatment apparatus used in a process of recovering lithium carbonate from a waste cathode material and a lithium carbonate recovery apparatus using the same are provided. The heat treatment apparatus includes a heat treatment furnace having an inlet through which an object to be treated is input and an outlet through which the heat-treated object is discharged, a support section rotatably supporting the heat treatment furnace, a burner provided in the heat treatment furnace to supply combustion gas to the heat treatment furnace, and an exhaust gas re-supply device re-supplying a portion of the combustion gas discharged from the heat treatment furnace to the heat treatment furnace, wherein the heat treatment furnace is divided into a first region in which the inlet is disposed, a second region connected to the first region, and a third region connected to the second region and in which the burner is disposed.

### CROSS REFERENCE TO RELATED APPLICATIONS

This application claims priority to Korean Patent Applications Nos. 10-2021-0053109, filed on Apr. 23, 2021 and 10-2021-0081739, filed on Jun. 23, 2021, the disclosures of which are incorporated herein by reference in their entireties.

### BACKGROUND

### 1. Field

Apparatuses and methods consistent with exemplary embodiments relate to a heat treatment apparatus used in a process of recovering lithium carbonate from a waste cathode material, and a lithium carbonate recovery apparatus using the same.

### 2. Description of the Related Art

There have been various attempts to extract useful resources by recycling waste materials. For example, attempts have been made to recover lithium carbonate from waste cathode materials produced in a process of producing cathode materials used for a secondary battery and from waste cathode materials recovered from waste batteries.

According to a method of recovering lithium carbonate from waste cathode materials (e.g., Ni/Co/Mn/Li) through heat treatment, the waste cathode materials are heat-treated by injecting gas such as hydrogen, nitrogen, methane, or carbon dioxide, in an oxygen-free reducing atmosphere so that lithium is converted into lithium oxide, lithium carbonate, etc. and is separated from the waste cathode materials.

The lithium carbonate (S) produced in this way is washed with water to phase-separate into a solid material (e.g., Ni/Mn/Co/Al) and a liquid material (e.g., lithium carbonate), and the separated liquid material is evaporated/condensed/crystallized to obtain high-purity lithium carbonate.

FIG. 1 illustrates an example of a related art heat treatment apparatus 10. Referring to FIG. 1, the related art heat treatment apparatus 10 uses an indirect heating batch type heat treatment, in which a waste cathode material is loaded in a heat treatment furnace 12 and then heat-treated in a CO₂ gas atmosphere or a waste cathode material and carbon C or sodium carbonate (Na₂CO₃) are loaded together and heat-treated in an oxygen-free atmosphere.

However, in the related art apparatus, because a wall surface of the heat treatment furnace is heated by a thermocouple 14, deposits may be attached to the wall surface of the heat treatment furnace due to the wall surface having higher temperature than internal temperature of the heat treatment furnace. This causes many problems such as a decrease in recovery rate, an increase in operation time required for cooling and restart of the heat treatment furnace to remove deposits, a greater amount of deposits on the wall surface at higher temperature, difficult to precisely control the temperature at temperature of the wall surface of the heat treatment furnace higher than the set temperature that is characteristic of the indirect heating method, limitation of attachment of deposits on the wall surface due to shape deformation of a stirrer, and limitation of capacity increase due to increase in thickness of stirrer due to expansion of the heat treatment furnace.

In addition, a CO₂ gas is introduced from an outside and a large amount of unreacted gas is discharged so that the amount of CO₂ gas used is increased more than necessary, thereby increasing the manufacturing cost.

### SUMMARY

Aspects of one or more exemplary embodiments provide a lithium carbonate-recovering heat treatment apparatus capable of minimizing the amount and emission of CO₂ gas while improving productivity.

Aspects of one or more exemplary embodiments also provide a lithium carbonate recovery apparatus having the heat treatment apparatus.

Additional aspects will be apparent in part in the description which follows and, in part, will become apparent from the description from the following description, or may be learned by practice of the exemplary embodiments.

According to an aspect of an exemplary embodiment, there is provided a heat treatment apparatus for recovery of lithium carbonate including: a heat treatment furnace having an inlet through which an object to be treated is input and an outlet through which the heat-treated object is discharged; a support section rotatably supporting the heat treatment furnace; a burner provided in the heat treatment furnace to supply combustion gas to the heat treatment furnace; and an exhaust gas re-supply device re-supplying a portion of the combustion gas discharged from the heat treatment furnace to the heat treatment furnace, wherein the heat treatment furnace is divided into a first region in which the inlet is disposed, a second region connected to the first region, and a third region connected to the second region and in which the burner is disposed.

30 to 60% of the exhaust gas may be re-supplied to the heat treatment furnace.

The exhaust gas supplied from the exhaust gas re-supply device may be supplied to the first region and the second region in larger amount than in the third region.

The heat treatment apparatus may further include at least one striking device disposed on an outer circumferential surface of the heat treatment furnace to apply an impact to the outer circumferential surface.

The at least one striking device may be arranged in a plurality of rows at intervals in a longitudinal direction of the heat treatment furnace.

A greater number of striking devices may be disposed in the third region than in the first and second regions.

The heat treatment furnace may include a plurality of baffles protruding in a radial direction.

A greater number of baffles may be disposed in the second region than in the first region.

The baffle disposed in the second region may have a distal end bent obliquely with respect to the other portion.

The baffle disposed in the first or third region may have a sheet plate shape.

The heat treatment apparatus may further include a CO₂ supply device supplying carbon dioxide to the heat treatment furnace.

According to an aspect of another exemplary embodiment, there is provided a lithium carbonate recovery apparatus including: a heat treatment apparatus as described above; a blower configured to re-supply the exhaust gas discharged from the heat treatment apparatus to the heat treatment furnace; a pulverizing device configured to pulverize solid reactants discharged from the heat treatment apparatus; a mixing device configured to mix reactant powder pulverized by the pulverizing device and distilled water; a filter configured to filter solid metals from the mixture obtained by the mixing device; and a solidification device configured to provide solid lithium carbonate by condensing/distilling/crystallizing liquid reactant that has passed through the filter.

The lithium carbonate recovery apparatus may further include a cyclone disposed between the heat treatment apparatus and the blower to recover powder contained in the exhaust gas discharged from the heat treatment apparatus.

The cyclone may include a first cyclone into which exhaust gas is introduced from the heat treatment furnace and a second cyclone or a gas cooler into which the exhaust gas is introduced and having a cooling device cooling the introduced exhaust gas.

The blower may selectively discharge a part of the introduced exhaust gas to the atmosphere.

The lithium carbonate recovery apparatus may further include a support section supporting the heat treatment apparatus.

The support section may include a first frame supporting the heat treatment furnace, a second frame fixed to the ground on which the heat treatment apparatus is installed to support the first frame, and first and second columns disposed between the first frame and the second frame. The second column may have a different length than the first column.

A length of the second column may be variable.

According to an aspect of another exemplary embodiment, there is provided a heat treatment apparatus for recovery of lithium carbonate including: a heat treatment furnace having an inlet through which an object to be treated is input and an outlet through which the heat-treated object is discharged; a support section rotatably supporting the heat treatment furnace; a burner provided in the heat treatment furnace to supply combustion gas to the heat treatment furnace; and at least one striking device disposed on an outer circumferential surface of the heat treatment furnace to apply an impact to the outer circumferential surface.

The heat treatment apparatus may further include an exhaust gas re-supply device re-supplying a portion of the combustion gas discharged from the heat treatment furnace to the heat treatment furnace.

According to one or more exemplary embodiments, because an input object is directly heated by a combustion gas generated from a burner, the wall surface temperature of the heat treatment furnace can be lowered, thereby minimizing a reduction in productivity due to wall adhesion. Here, the rotation of the heat treatment furnace further restricts the continuous contact and adhesion of the heat-treated waste cathode material with respect to the wall surface to allow for uniform contact and reaction between the waste cathode material and exhaust gas.

Also, a small amount of waste cathode material can be easily separated from the wall surface by an impact applied through a striking device.

In addition, the baffles mounted in the heat treatment furnace enables a heat treatment target to be evenly dispersed in the heat treatment furnace, thereby activating contact with the combustion gas, and the baffles can also reduce the adhesion of the heat treatment target to the wall surface.

According to one or more exemplary embodiments, CO₂ gas contained in the combustion gas is used during the heat treatment process. Accordingly, additional input of CO₂ gas is not required, and the overall structure of the apparatus can be simplified. For example, LPG or LNG can be used as a fuel of the burner, thereby maintaining an eco-friendly production process.

Further, a portion of the discharged combustion gas is re-supplied to the heat treatment furnace through an exhaust gas recirculation device, so that the concentration of CO₂ in the heat treatment furnace can be appropriately adjusted. The temperature of the re-supplied combustion gas can be controlled by a separate cooling device, so that the temperature and CO₂ concentration in the heat treatment furnace can be controlled freely.

### BRIEF DESCRIPTION OF THE DRAWINGS

The above and other aspects will be more apparent from the following description of the exemplary embodiments with reference to the accompanying drawings, in which:

FIG. 1 is a schematic diagram illustrating a related art heat treatment apparatus;

FIG. 2 is a cross-sectional view schematically illustrating a heat treatment apparatus according to an exemplary embodiment;

FIGS. 3A and 3B are cross-sectional views illustrating various examples of an exhaust gas re-supply device that may be provided in the embodiment of FIG. 2;

FIG. 4 is a flowchart illustrating an example of a lithium carbonate recovery process using the embodiment of FIG. 2;

FIG. 5 is a flowchart illustrating the lithium carbonate recovery process in more detail;

FIG. 6 is a schematic diagram illustrating a recovery apparatus for performing the lithium carbonate recovery process;

FIG. 7 is a schematic diagram illustrating a heat treatment furnace having baffles according to an exemplary embodiment;

FIGS. 8A, 8B, 9A and 9B are cross-sectional views illustrating a shape of a baffle according to a position of the heat treatment furnace;

FIGS. 10A and 10B are schematic diagrams illustrating modified examples of a striking device provided in the heat treatment furnace;

FIG. 11 is a graph illustrating an amount of lithium recovered according to the exhaust gas re-supply device; and

FIG. 12 is a side view illustrating an example in which the embodiment illustrated in FIG. 2 is employed.

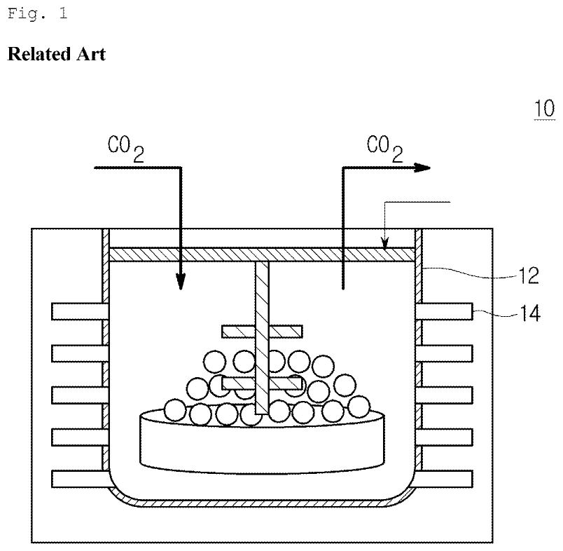

### DETAILED DESCRIPTION

Various modifications and various embodiments will be described below in detail with reference to the accompanying drawings so that those skilled in the art can easily carry out the disclosure. It should be understood, however, that the various embodiments are not for limiting the scope of the disclosure to the specific embodiment, but they should be interpreted to include all modifications, equivalents, and alternatives of the embodiments included within the spirit and scope disclosed herein.

The terminology used herein is for the purpose of describing specific embodiments only and is not intended to limit the scope of the disclosure. The singular expressions “a”, “an”, and “the” are intended to include the plural expressions as well unless the context clearly indicates otherwise. In the disclosure, terms such as “comprises”, “includes”, or “have/has” should be construed as designating that there are such features, integers, steps, operations, components, parts, and/or combinations thereof, not to exclude the presence or possibility of adding of one or more of other features, integers, steps, operations, components, parts, and/or combinations thereof.

Exemplary embodiments will be described below in detail with reference to the accompanying drawings. It should be noted that like reference numerals refer to like parts throughout the various figures and exemplary embodiments. In certain embodiments, a detailed description of functions and configurations well known in the art may be omitted to avoid obscuring appreciation of the disclosure by a person of ordinary skill in the art. For the same reason, some components may be exaggerated, omitted, or schematically illustrated in the accompanying drawings.

Hereinafter, a heat treatment apparatus according to an exemplary embodiment will be described with reference to the accompanying drawings.

FIG. 2 illustrates a heat treatment apparatus 100 according to an exemplary embodiment. Referring to FIG. 2, a heat treatment furnace 110 of the heat treatment apparatus 100 has a hollow cylindrical shape and is internally provided with a heat treatment space 112 into which a heat treatment object, that is, a waste cathode material is put therein. However, it is understood that the heat treatment object is not limited thereto. For example, the heat treatment object may include a cathode material recovered from defective product produced during processing a cathode material for secondary batteries, a cathode material recovered from cathode scraps generated during a battery manufacturing process, and a cathode material recovered from a battery used in an electric vehicle or ESS.

The heat treatment furnace 110 may include an inlet into which a waste cathode material is input and an outlet 120 through which the heat treated waste cathode material is discharged. The inlet and outlet 120 are spaced apart from each other along a longitudinal direction of the heat treatment furnace 110. Here, the heat treatment furnace 110 is inclined with respect to the gravity direction such that a height of the outlet 120 is lower than that of the inlet. In FIG. 2, the heat treatment furnace 110 is disposed lower on the right side than on the left side. This configuration has a structure in which the waste cathode material injected during the heat treatment process can be discharged by gravity while moving toward the outlet 120.

The outside of the heat treatment furnace 110 is covered with a thermal insulating cover 114 or any suitable insulating material. Thus, the interior of the heat treatment furnace 110 can be maintained at a proper temperature range. A plurality of striking devices 130 are mounted on the heat treatment furnace 110. The striking devices 130 may separate a waste cathode material deposited on an inner wall surface of the heat treatment furnace by applying an impact a wall surface of the heat treatment furnace 110.

The striking devices 130 are arranged radially along a circumferential surface of the heat treatment furnace 110. Also, the striking devices 130 are arranged at regular intervals along a longitudinal direction of the heat treatment furnace 110. Here, the number of striking devices 130 disposed along the longitudinal direction of the heat treatment furnace may be set to have the same or different number.

For example, if the length of the heat treatment furnace is not long and the internal temperature gradient is small, the same number of striking devices may be disposed in each row. If the length of the heat treatment furnace is long and the temperature gradient is also large, the degree of adhesion of the waste cathode material may vary along the longitudinal direction of the heat treatment furnace. A larger number of striking devices may be disposed at points in which adhesion occurs relatively frequently, for example, near the burner. In addition, intervals between each row can also be arranged appropriately and differentially according to the degree of adhesion.

In FIG. 2, four to six striking devices are provided in a row such that 10 to 20 kg weight (hammer) is set to collide with the outer circumferential surface of the heat treatment furnace to apply an impact of 30 N·s or more.

Although not shown in FIG. 2, an actuator for rotating the heat treatment furnace 110 about its central axis may be provided. The actuator rotates the heat treatment furnace at a predetermined rotational speed, which may be appropriately adjusted according to an amount of the supplied waste cathode material, combustion status of a burner, a concentration of CO₂, and the like. For example, the rotational speed may preferably be set in a range of 1 rpm to 10 rpm. If the rotational speed is slow, the productivity may be reduced due to prolonged transfer of a raw material, and if the rotational speed is fast, the residence time of the waste cathode material in the heat treatment furnace may decrease, thereby inhibiting the reaction of the waste cathode material. Accordingly, the rotational speed can be properly set in consideration of these factors.

In this regard, an angle at which the heat treatment furnace is disposed may be considered. In the above example, the heat treatment furnace 110 is disposed at an angle from 0.5° to 2° with respect to the ground surface. The effect of the angle is similar to the rotational speed of the heat treatment furnace. That is, if the angle is too small, the residence time increases, and if the angle is too large, the residence time decreases, so that the rotational speed and alignment angle may be considered together.

Here, a suitable residence time of the reactants may range from 1 to 4 hours.

The burner 140 is mounted on one side of the heat treatment furnace 110. For example, a single burner 140 may be mounted at the center of the heat treatment furnace 110, a plurality of burners may be mounted, or a burner may be provided outside the heat treatment furnace such that only combustion gas is supplied into the heat treatment furnace.

The burner 140 burns a fuel such as LPG or LNG in the heat treatment furnace. The thermal energy generated in this process can be utilized to raise the temperature inside the heat treatment furnace 110, and the CO₂ gas contained in the combustion gas maintains the inside of the heat treatment furnace in a CO₂ atmosphere to cause carbonation of lithium in the waste cathode material. Unlike the related art, because the heat treatment is performed while generating the CO₂ gas by itself without supplying it from the outside, the overall structure can be simplified and the amount of CO₂ used can be remarkably reduced.

In some cases, the required flow rate of CO₂ may be greater than the amount of CO₂ supplied from the combustion gas, in which case CO₂ may be supplied from the outside. Although the complexity of the apparatus may increase, it is still possible to reduce the usage of CO₂ compared to the related art.

Here, the internal temperature of the heat treatment furnace is preferably maintained at 500 to 800° C. In the case of using the heat treatment furnace having the above structure, it was found that the lithium carbonate conversion reaction proceeds only when the temperature is 500° C. or higher. In addition, it was found that the conversion rate increased as the internal temperature increased, but at 800° C. or higher, the conversion rate increase rate according to the increase in temperature was not large, and there was a problem in that the productivity decreased due to the increased adhesion of the waste cathode material powder. Therefore, the internal temperature is preferably in the range of 500 to 800° C., and more preferably in the range of 600 to 700° C.

In addition, it was confirmed that the converted lithium carbonate was pyrolyzed again at 1000° C. or higher, and the recovery rate of lithium carbonate was rather decreased.

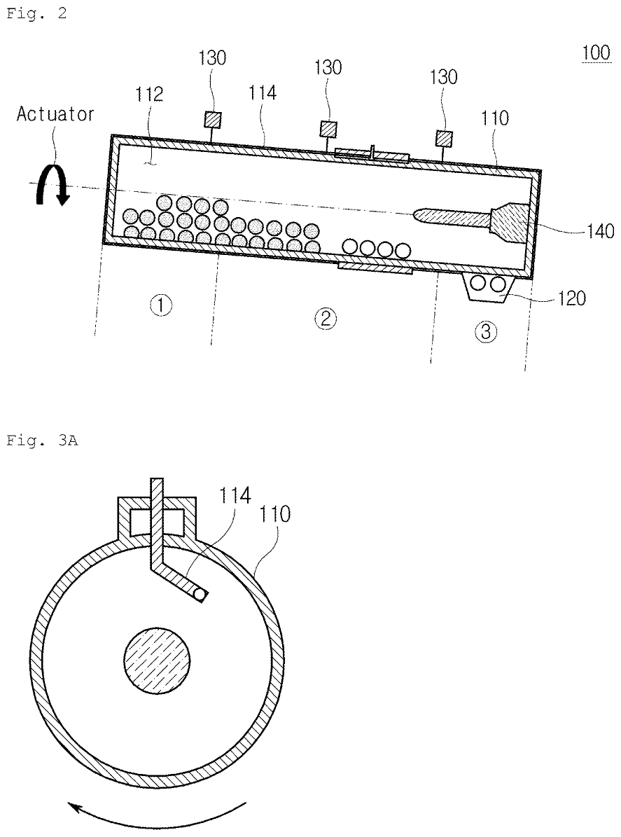

As an alternative to the CO₂ supply, a method of re-supplying a portion of the exhausted combustion gas to the heat treatment furnace 110 as illustrated in FIG. 3 may also be considered. That is, the unreacted remaining CO₂ of the exhaust gas is recycled by re-supplying the exhaust gas. Accordingly, the heat treatment can be performed without separate CO₂ supply, and harmful gas such as hydrocarbons, CO and NOx contained in the exhaust gas can be reduced.

After being discharged from the heat treatment furnace and cooled or heated, the exhaust gas may be supplied. Because the internal temperature of the heat treatment furnace may change due to the supply of the exhaust gas, the exhaust gas may be re-supplied after properly adjusting the temperature to avoid the change.

Referring to FIG. 2, when the internal space of the heat treatment furnace 110 is divided into three space sections in the direction from the inlet to the outlet, the space section adjacent to an end opposite to an end in which the burner 140 is disposed is referred to as a first region \textcircled{1}, the middle space section is referred to as a second region \textcircled{2}, and the space section adjacent to the burner 140 is referred to as a third region \textcircled{3}. The exhaust gas may be supplied to the first region and the second region. Here, the first region is provided with the inlet through which the waste cathode material is loaded.

Because the first and second regions are located relatively far from the burner 140, a sufficient amount of heat may not be supplied. In order to prevent this, if an amount of heat supplied from the burner 140 is increased, the temperature of the third region adjacent to the burner 140 may be excessively increased, thereby increasing the adhesion rate or the like.

However, as described above, it is possible to uniformly raise the internal temperature of the heat treatment furnace 110 by injecting high-temperature exhaust gas into the first and second regions. In addition, the waste cathode material disposed in the first and second regions requires a larger amount of CO₂ because the first and second regions exhibit relatively low reacting performance compared to the third region. Accordingly, it is necessary to supply the exhaust gas to the first and second regions in order to further promote the reacting performance and increase the amount of the exhaust gas used.

Here, the input of the exhaust gas is preferably 30 to 60% by volume of the exhaust gas generated in the combustion process in the burner. If the input of the exhaust gas is less than 30%, the exhaust amount is insufficient and the effect of exhaust gas cannot be sufficiently obtained. If the input of the exhaust gas is more than 60%, because the exhaust amount in the heat treatment furnace increases, it is necessary to increase the capacity of the related equipment by adding heat to maintain the internal temperature, so that the process efficiency decreases.

The internal pressure of the heat treatment furnace is preferably maintained at 0.1 to 1 bar. If the internal pressure of the heat treatment furnace is lower than atmospheric pressure, the reaction between carbon dioxide and lithium in the waste cathode material powder does not occur well, and if the internal pressure increases, the partial pressure of carbon dioxide increases, thereby improving the reaction rate. However, if the internal pressure is 1 bar or more, the performance of the burner and a blower for re-supplying exhaust gas should be increased, and additional measures to prevent leakage are required.

In addition to the exhaust gas re-supply, it is preferable to adjust an air-fuel ratio so that concentrations of oxygen and carbon dioxide of the combustion gas generated in the combustion process are 0.5 to 2% and 11 to 14%, respectively. If the oxygen content is 2% or more, the lithium carbonate conversion rate is reduced due to a side reaction of lithium conversion, and if the oxygen content is 0.5% or less, the amount of pollutants (e.g., CO and unburned hydrocarbons) increases. In addition, if the carbon dioxide content is 11% or less, the lithium carbonate reaction does not occur well due to low carbon dioxide partial pressure, and in a case of air and LNG/LPG hybrid combustion, it is inefficient because it is not easy to increase the carbon dioxide content to more than 14%.

FIGS. 3A and 3B are cross-sectional views illustrating examples of an exhaust gas re-supply device that may be provided in the embodiment of FIG. 2. Referring to FIGS. 3A and 3B, a nozzle for supplying the re-supplied exhaust gas is provided in the heat treatment furnace 110. In FIG. 3A, a single nozzle 114 may be provided, and in FIG. 3B, a multi-nozzle 116 having a plurality of injection holes may be provided along the periphery of the nozzle around the burner in the heat treatment furnace 110.

Here, the single nozzle 114 may be inclined toward a rotational direction of the heat treatment furnace 110 such that the exhaust gas injected through the nozzle may flow along the rotational direction of the heat treatment furnace 110 so that the exhaust gas can be mixed evenly with a combustion gas flow in the heat treatment furnace 110.

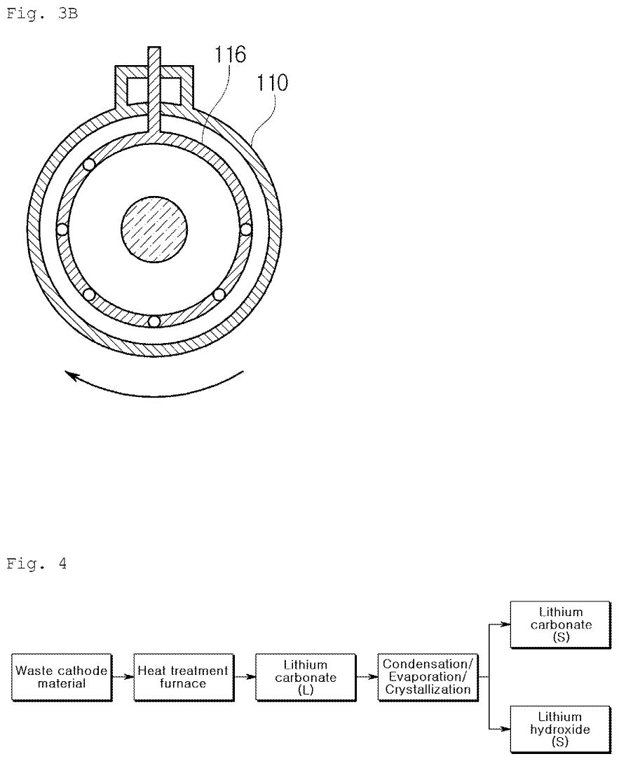

FIG. 4 schematically illustrates a lithium carbonate recovery process using the heat treatment furnace. Referring to FIG. 4, a waste cathode material is carbonized through the heat treatment furnace and converted into liquid lithium carbonate, which is condensed/evaporated/crystallized to obtain solid lithium carbonate or lithium hydroxide.

FIG. 5 is a flowchart illustrating the lithium carbonate recovery process in more detail. Referring to FIG. 5, a waste battery or a waste cathode material is pulverized after being heat-treated through the heat treatment furnace as described above. The pulverized waste battery is mixed with distilled water, and the mixture contains liquid lithium carbonate and solid residues. A solid component (i.e., a valuable metal) may be separated from the mixture by a gas-liquid separator to obtain liquid lithium carbonate.

The liquid lithium carbonate may be condensed/evaporated/crystallized to obtain solid lithium carbonate. On the other hand, liquid lithium hydroxide can be obtained by adding barium hydroxide to the liquid lithium carbonate, and the liquid lithium hydroxide can be condensed/evaporated/crystallized to obtain solid lithium hydroxide.

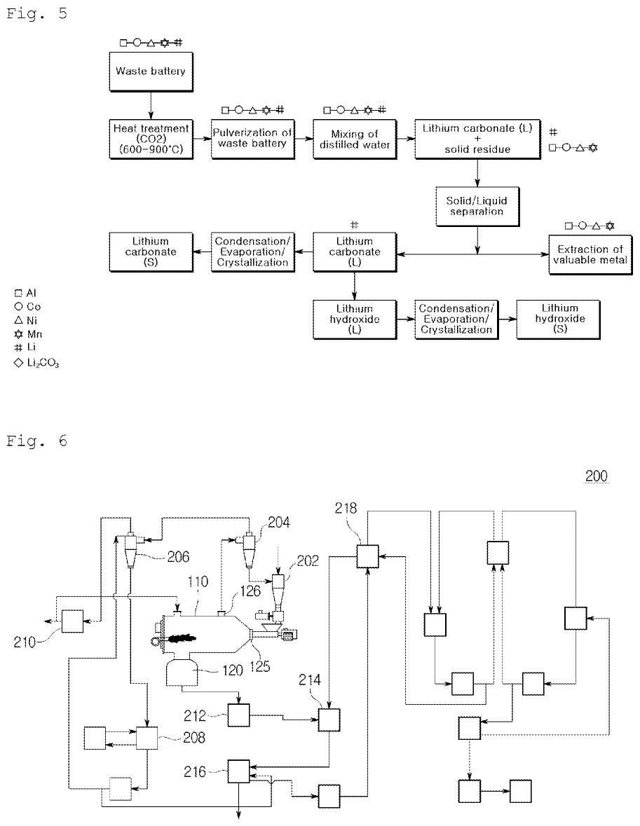

FIG. 6 schematically illustrates a recovery apparatus 200 for performing the lithium carbonate recovery process.

Referring to FIG. 6, a waste cathode material is supplied through a hopper 202 connected to an inlet 125 of the heat treatment furnace 110, is heat-treated and discharged to the outside. Here, the heat treatment furnace 110 includes an outlet port 126 for discharging an exhaust gas, the outlet port 126 being connected to a primary cyclone 204. The primary cyclone 204 collects the waste cathode material powder contained in the exhaust gas to reduce material waste by re-supplying the collected waste cathode material powder to the hopper 202.

It is understood that the cyclone may employ any filter unit such as a bag filter in addition to the above-described cyclone method.

The exhaust gas in which the waste cathode material powder is filtered through the primary cyclone 204 is supplied to a secondary cyclone 206. The secondary cyclone 206 filters out remaining foreign substances and cools the exhaust gas through heat exchange between cooling water supplied from a cooling water tank 208 and the exhaust gas. For example, the cooling water is injected toward the exhaust gas from the secondary cyclone 206 to cool the exhaust gas and collect fine powder contained in the exhaust gas. Because the exhaust gas is cooled by the cooling water, the exhaust gas does not damage a blower fan 210 installed to supply the exhaust gas to the heat treatment furnace 110.

A pressure filter may be used in the secondary cyclone 206 to recover a small amount of powder.

A portion of the cooled exhaust gas is re-supplied to the atmosphere and the remaining portion of the cooled exhaust gas is supplied to the heat treatment furnace 110 by the blower fan 210.

Here, the ratio of the exhaust gas discharged to the atmosphere and the temperature of the exhaust gas supplied to the heat treatment furnace may be appropriately adjusted according to the heat treatment situation.

The heat-treated waste cathode material is supplied to a ball mill 212 through an outlet 120 and pulverized to a size of 500 μm or less. The pulverized waste cathode material is transferred to a stirring unit 214 and leached with distilled water. At this time, pure water (e.g., 5 μs/cm or less) is used as distilled water, and the weight ratio of waste cathode material to water is 1:20 to 1:50.

The water leaching is carried out for 30 minutes to 2 hours, and the water leaching may be performed by dry crushing and stirring unit or only by a wet crushing device. The water-leached mixture is supplied to a filter unit 216 for solid-liquid separation. Valuable metals such as cobalt, nickel, and manganese present in the mixture are separated by the filter unit 216. The separated valuable metal may be dried by a dryer. When the valuable metal is separated, a lithium carbonate or lithium contained solution is extracted and transferred to a rotary crystallization device (CDI) 218 to produce lithium carbonate products.

The transferred separation solution is crystallized into lithium carbonate in the rotary crystallization device 218. The rotary crystallization device 218 includes a common CDI, a charged water tank, a rotary CDI, a discharged water tank, and a vacuum filter. When lithium carbonate is crystallized in the discharged water tank, an endothermic reaction occurs, so a heater is used to maintain the discharged water tank at temperature 10° C. higher than room temperature.

In order to increase the contact area between input reactant and combustion gas in the heat treatment furnace 110, a baffle radially protruding from an inner wall surface of the heat treatment furnace 110 may be provided. For example, three to nine baffles may be installed in the circumferential direction so that samples can be stirred well, and may be installed in a plurality of rows along the longitudinal direction. In this case, when viewed from one end of the heat treatment furnace 110, the baffles provided in each row may be alternately disposed.

The baffles may not be installed near the outlet 120 adjacent to burning flame and near the inlet 125 or the outlet port 126, otherwise no more than three baffles may be installed there. In this case, the baffle may have a sheet shape. If the baffles are installed near the inlet 125 or the outlet port 126, a large amount of raw material is scattered, increasing the amount of raw material lost in the exhaust gas. Further, if the baffles are installed near the outlet 120, there is a risk of lithium volatilization or decomposition of lithium carbonate due to the high temperature generated by the contact between the reactants and the combustion flame.

The length of the baffle may be 0.5 times the diameter of the heat treatment furnace 110, and the height of the baffle may be 0.1 times the diameter of the heat treatment furnace 110. In addition, the baffle may be an elongated sheet plate or may have a form of a hook.

FIG. 7 schematically illustrates the heat treatment furnace 110 having baffles 150. Referring to FIG. 7, the baffles 150 are installed in a plurality of rows. For example, the baffles 150 are disposed in first to third regions \textcircled{1}, \textcircled{2}, \textcircled{3}. In some cases, the baffles 150 may not be installed in some regions such as the first or third region.

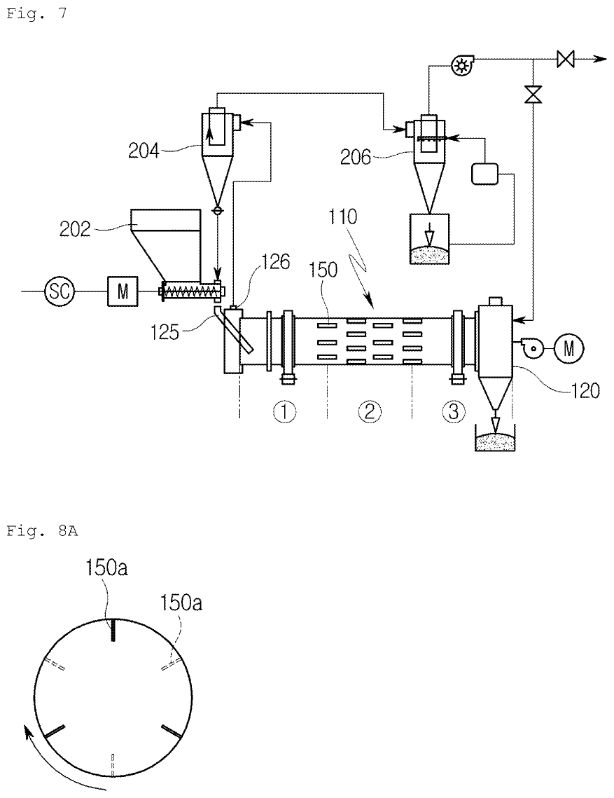

As described above, the number of baffles provided in each row may be the same or different. Referring to FIG. 8A, three baffles 150a are disposed in one row in the first region, and the baffles disposed in each row have a thin plate shape. Referring to FIG. 8B, when viewed from the side of the heat treatment furnace 110, the rows are installed alternately so as not to overlap each other.

The first region \textcircled{1} is provided with the inlet 125 through which waste cathode material powder is input and the outlet port 126 through which exhaust gas is discharged, and preheating of the waste cathode material powder and removing a binder included in the powder are performed. Therefore, when the powder is excessively stirred or scattered in the region, a large amount of dust is generated and discharged to the outside through the outlet port 126. To this end, a relatively small number of sheet-type baffles having a relatively low scattering effect are installed.

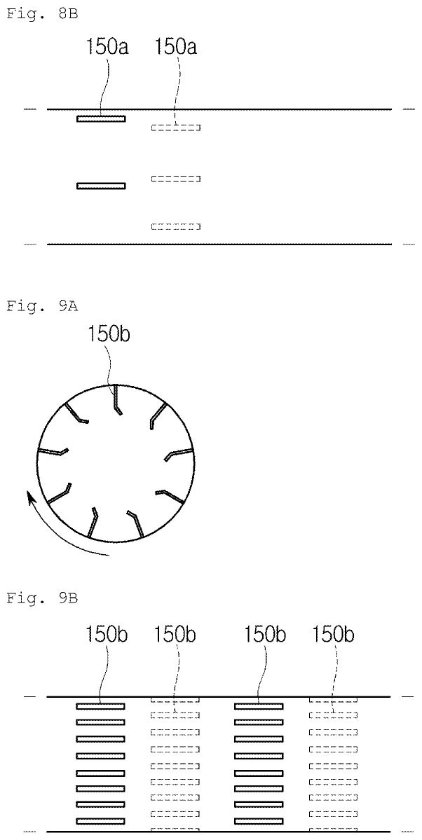

On the other hand, in the second region \textcircled{2}, as illustrated in FIGS. 9A and 9B, hook-shaped baffles 150b having bent ends are alternately disposed. At this time, nine baffles are installed in each row. Here, although not necessarily limited to nine, the number of baffles in the second region is preferably greater than the number of baffles in the first region. The bent end of the baffle 150b delays the reactants from falling after being transported higher so that the reactants can be evenly distributed at various points inside the heat treatment furnace. Accordingly, the contact area with the combustion gas can be increased. However, if the number of baffles is excessively increased to improve the scattering effect, there may be a problem that the waste cathode material powder adheres between the baffles, so it is preferable to install nine or less baffles.

Here, an interval between the baffles may be 0.6 to 2 m, which may vary depending on the type and state of a raw material to be treated. When converting a waste cathode material to lithium carbonate by heat treatment, the interval may be 0.6 m.

Further, the third region \textcircled{3} is provided with a baffle having the same shape as the first region \textcircled{1}. The third region is a section in which the heat-treated powder is discharged and the burner is installed. In the case of lithium carbonate after the reaction has been completed in the heat treatment furnace, it is necessary to appropriately control the amount of scattering because it is thermally decomposed into Li₂O and CO₂ again at 1000° C. or higher. That is, if the scattering is excessive, the reacted lithium carbonate may be thermally decomposed in contact with the flame of the burner, so that the number of baffles is equal to or less than the number of baffles in the first region.

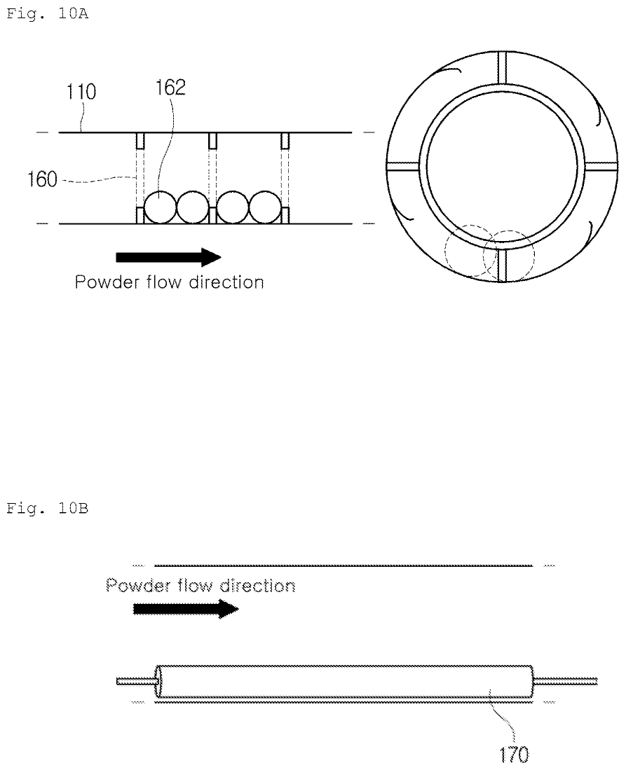

FIGS. 10A and 10B illustrate possible variants of the striking device. Referring to FIG. 10A, the heat treatment furnace 110 may be provided with a plurality of vanes 160 and a plurality of iron balls 162 whose movement is restricted by the vanes 160. The iron balls 162 are transferred upward by the vanes 160 according to the rotation of the heat treatment furnace 110. If the heat treatment furnace 110 rotates more than a certain angle, the iron balls 162 fall to a lower part of the heat treatment furnace 110 and apply an impact. The amount of impact applied may be adjusted according to the number and shape of the vanes 160 and the size or number of the iron balls 162.

Referring to FIG. 10B, a bar 170 for milling is installed in the heat treatment furnace 110. The attached reactants are separated by rotating the bar while rubbing against an inner wall surface of the heat treatment furnace.

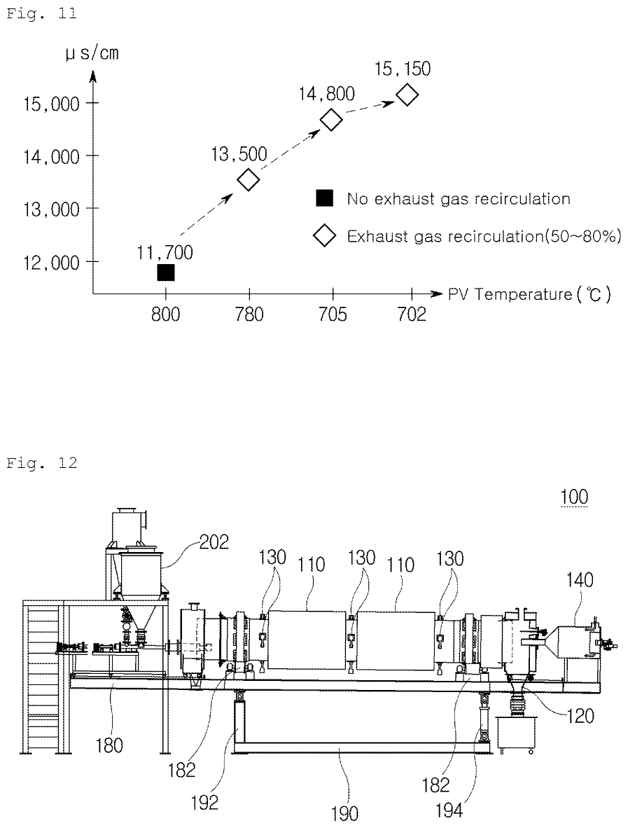

FIG. 11 is a graph showing an effect of exhaust gas re-supply in a heat treatment furnace. Referring to FIG. 11, when only the combustion gas of the burner is used without re-supply of exhaust gas, conductivity of a lithium recovery solution was 11700 μs/cm, while when the exhaust gas was supplied at the exhaust gas re-supply rate of 0.5 to 0.8, the lithium recovery conductivity was increased to 15150 μs/cm.

In addition, as a result of checking the color of the lithium carbonate water leachate, it was indirectly confirmed that the lithium carbonate water leachate showed a transparent color without yellow due to the fluorine contained in the waste cathode material, so that sufficient heat treatment and carbonation were performed.

FIG. 12 is a view illustrating an example in which the heat treatment furnace 110 is mounted. Referring to FIG. 12, the heat treatment furnace 110 is supported on an upper portion of a first frame 180 extending in a transverse direction, and two bearing parts 182 are installed in the first frame 180. The bearing part 182 rotatably supports an outer circumferential surface of the heat treatment furnace 110 so that the heat treatment furnace 110 is freely rotatably supported with respect to the first frame 180.

The first frame 180 is supported by a second frame 190. The second frame 190 is fixed to the ground in which the heat treatment furnace 110 is installed, and supports the first frame 180 to be spaced apart from the ground through first and second columns 192 and 194.

The first and second columns 192 and 194 are set to have different heights, and due to this height difference, the first frame 180 and the heat treatment furnace 110 fixed to the first frame 180 are inclined with respect to the ground to have an angle as described above. Here, the second column 194 may have a fixed length, and may be configured to change the length as needed. For example, an upper end of the second column 194 can be raised or lowered using a hydraulic device, so that an alignment angle of the heat treatment furnace 110 can be freely adjusted. Therefore, it is possible to adjust the residence time of a waste cathode material according to the reaction rate in the heat treatment furnace 110.

While exemplary embodiments have been described with reference to the accompanying drawings, it is to be understood by those skilled in the art that various modifications in form and details may be made therein without departing from the sprit and scope as defined by the appended claims. Therefore, the description of the exemplary embodiments should be construed in a descriptive sense and not to limit the scope of the claims, and many alternatives, modifications, and variations will be apparent to those skilled in the art.

What is claimed is:

1. A heat treatment apparatus for recovery of lithium carbonate, the apparatus comprising:
a heat treatment furnace having an inlet through which an object to be treated is input and an outlet through which the heat-treated object is discharged;
a support section rotatably supporting the heat treatment furnace;
a burner provided in the heat treatment furnace to supply combustion gas to the heat treatment furnace; and
an exhaust gas re-supply device re-supplying a portion of the combustion gas discharged from the heat treatment furnace to the heat treatment furnace,
wherein the heat treatment furnace is divided into a first region in which the inlet is disposed, a second region connected to the first region, and a third region connected to the second region and in which the burner is disposed.

2. The apparatus according to claim 1, wherein 30 to 60% of the exhaust gas is re-supplied to the heat treatment furnace.

3. The apparatus according to claim 1, wherein the exhaust gas supplied from the exhaust gas re-supply device is supplied to the first region and the second region in larger amount than in the third region.

4. The apparatus according to claim 1, further comprising at least one striking device disposed on an outer circumferential surface of the heat treatment furnace to apply an impact to the outer circumferential surface.

5. The apparatus according to claim 4, wherein the at least one striking device is arranged in a plurality of rows at intervals in a longitudinal direction of the heat treatment furnace.

6. The apparatus according to claim 5, wherein a greater number of striking devices are disposed in the third region than in the first and second regions.

7. The apparatus according to claim 1, wherein the heat treatment furnace includes a plurality of baffles protruding in a radial direction.

8. The apparatus according to claim 7, wherein a greater number of baffles are disposed in the second region than in the first region.

9. The apparatus according to claim 8, wherein the baffle disposed in the second region has a distal end bent obliquely with respect to the other portion.

10. The apparatus according to claim 8, wherein the baffle disposed in the first or third region has a sheet plate shape.

11. The apparatus according to claim 1, further comprising a CO₂ supply device supplying carbon dioxide to the heat treatment furnace.

12. A lithium carbonate recovery apparatus comprising:
a heat treatment apparatus according to claim 1;
a blower configured to re-supply the exhaust gas discharged from the heat treatment apparatus to the heat treatment furnace;
a pulverizing device configured to pulverize solid reactants discharged from the heat treatment apparatus;
a mixing device configured to mix reactant powder pulverized by the pulverizing device and distilled water;
a filter configured to filter solid metals from the mixture obtained by the mixing device; and
a solidification device configured to provide solid lithium carbonate by condensing/distilling/crystallizing liquid reactant that has passed through the filter.

13. The lithium carbonate recovery apparatus according to claim 12, further comprising a cyclone disposed between the heat treatment apparatus and the blower to recover powder contained in the exhaust gas discharged from the heat treatment apparatus.

14. The lithium carbonate recovery apparatus according to claim 13, wherein the cyclone comprises:
a first cyclone into which exhaust gas is introduced from the heat treatment furnace; and
a second cyclone into which the exhaust gas is introduced and having a cooling device cooling the introduced exhaust gas.

15. The lithium carbonate recovery apparatus according to claim 12, wherein the blower selectively discharges a part of the introduced exhaust gas to the atmosphere.

16. The lithium carbonate recovery apparatus according to claim 12, further comprising a support section supporting the heat treatment apparatus.

17. The lithium carbonate recovery apparatus according to claim 16, wherein the support section comprises:
a first frame supporting the heat treatment furnace;
a second frame fixed to the ground on which the heat treatment apparatus is installed to support the first frame; and
first and second columns disposed between the first frame and the second frame,
wherein the second column has a different length than the first column.

18. The lithium carbonate recovery apparatus according to claim 17, wherein a length of the second column is variable.

19. A heat treatment apparatus for recovery of lithium carbonate, the apparatus comprising:
a heat treatment furnace having an inlet through which an object to be treated is input and an outlet through which the heat-treated object is discharged;
a support section rotatably supporting the heat treatment furnace;
a burner provided in the heat treatment furnace to supply combustion gas to the heat treatment furnace; and
at least one striking device disposed on an outer circumferential surface of the heat treatment furnace to apply an impact to the outer circumferential surface.

20. The apparatus according to claim 19, further comprising an exhaust gas re-supply device re-supplying a portion of the combustion gas discharged from the heat treatment furnace to the heat treatment furnace.
